(19) United States
(12) Patent Application Publication
(10) Pub. No.: US 2023/0150666 A1
(43) Pub. Date: May 18, 2023

(54) Firefighting Helicopter Quick-Fill System

(71) Applicant: Carlos Avila, Barstow, CA (US)

(72) Inventor: Carlos Avila, Barstow, CA (US)

(21) Appl. No.: 17/933,901

(22) Filed: Sep. 21, 2022

Related U.S. Application Data
(60) Provisional application No. 63/279,258, filed on Nov. 15, 2021.

(51) Int. Cl. B64D 1/22; B64D 1/16

(52) U.S. Cl. CPC B64D 1/22; B64D 1/16

(57) ABSTRACT

The present invention relates to a firefighting helicopter quick-fill system with a filling device primarily comprised of a first end with at least one receiver and a second end comprised of at least one female connector, wherein the first end and the second end are connected by at least one tubing. To use the device, the receiver can be attached to a male nozzle of a firefighting helicopter and the female connector can then be attached to a fire hydrant such that water can be pumped from the fire hydrant, through the tubing, through the connector, and into the helicopter via the male nozzle.

### CROSS-REFERENCE TO RELATED APPLICATION

The present application claims priority to, and the benefit of, U.S. Provisional Application No. 63/279,258, which was filed on Nov. 15, 2021, and is incorporated herein by reference in its entirety.

### FIELD OF THE INVENTION

The present invention relates generally to the field of aerial firefighting. More specifically, the present invention relates to a firefighting helicopter quick-fill system with a filling device primarily comprised of a first end with at least one receiver and a second end comprised of at least one female connector, wherein the first end and the second end are connected by at least one tubing. To use the device, the receiver can be attached to a male nozzle of a firefighting helicopter and the female connector can then be attached to a fire hydrant such that water can be pumped from the fire hydrant, through the tubing, through the connector, and into the helicopter via the male nozzle. Accordingly, the present disclosure makes specific reference thereto. Nonetheless, it is to be appreciated that aspects of the present invention are also equally applicable to other like applications, devices, and methods of manufacture.

### BACKGROUND

In areas of the United States where wildfires are prevalent, aerial vehicles such as helicopters and planes are often used to dump large amounts of water onto said wildfires in attempt to extinguish said wildfires. Helicopters are often specifically outfitted with a bucket-like attachment or tank. A helicopter then lowers the attachment or a hose-like nozzle into a large body of water such as a lake, reservoir, river, ocean, or pool to fill the attachment/tank with water that can be dumped on a wildfire. However, said bodies of water are often not available for use depending on the location of the wildfire. In contrast, fire hydrants are often an available water source, especially in residential areas.

Therefore, there exists a long-felt need in the art for a system that allows a firefighting helicopter to easily receive water. There also exists a long-felt need in the art for a helicopter water filling system that allows a firefighting helicopter to be easily filled with water to combat wildfires without requiring a large body of water or water source to fill said helicopter. In addition, there exists a long-felt need in the art for a helicopter water filling system that allows a helicopter to be easily filled with water to combat wildfires without requiring a large body of water or water source to fill said helicopter that also reduces the amount of travel time needed from a body of water to a wildfire.

The subject matter disclosed and claimed herein, in one embodiment thereof, comprises a firefighting helicopter quick-fill system. The system is comprised of a filling device primarily comprised of a first end with at least one receiver and a second end comprised of at least one female connector, wherein the first end and the second end are connected by at least one tubing. The system is also comprised of a method of using the device. To use the device, the receiver can be attached to a male nozzle of a firefighting helicopter. The female connector can then be attached to a fire hydrant such that water can be pumped from the fire hydrant, through the tubing, through the connector, and into the helicopter via the male nozzle. The receiver allows quick connection/disconnection of the device from the helicopter.

In this manner, the firefighting helicopter quick-fill system of the present invention accomplishes all of the foregoing objectives and provides a firefighting helicopter quick-fill system that allows a firefighting helicopter to easily receive water without requiring a large body of water or water source to fill a firefighting helicopter. In addition, the device reduces the amount of travel time needed from a body of water to a wildfire by allowing a firefighting helicopter to be filled using more readily available fire hydrants.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a firefighting helicopter quick-fill system. The system is comprised of a filling device that attaches to a helicopter nozzle and a fire hydrant. The device is primarily comprised of a first end with at least one receiver and a second end comprised of at least one female connector, wherein the first end and the second end are connected by at least one tubing. The system is also comprised of a method of using the device.

The first end of the device is comprised of at least one receiver with at least one top opening and at least one bottom opening. The top opening allows a male helicopter nozzle to connect to the device for water filling, wherein the nozzle is received by at least one connector positioned within the receiver. The connector is preferably a plunger of any plunger type known in the art. The plunger is preferably comprised of at least one spring such that the plunger is spring-loaded. In this manner, the plunger can be pushed against the nozzle such that the plunger is secured around the nozzle.

The bottom opening of the receiver may be fixedly or removably attached to the tubing such that the receiver and tubing are in fluid communication. The tubing may be attached to the opening via at least one connecting fastener. The tubing connects to at least one female connector at the second end of the device. The tubing may fixedly connect to the connector or may be removably connected via at least one connecting fastener. The connector preferably has at least one rear opening and at least one front opening, wherein the front opening allows a male fire hydrant connector to connect to the device for water filling. The interior wall of the connector is preferably comprised of at least one thread that is a male or female reciprocating thread which corresponds to the opposite thread found on the fire hydrant. In this manner, the connector can be threaded onto the fire hydrant using at least one handle located on the connector.

In one embodiment, the flow of water from the fire hydrant through the tubing to the nozzle can be controlled by at least one valve. In one embodiment, the device may be comprised of at least one brace, wherein a first end of the brace preferably attaches to the receiver via at least one fastener. The second end of the brace further attaches to the female connector via at least one fastener.

The system is also comprised of a method of use. A user can first attach the female connector to a fire hydrant by turning the threads of the connector onto the hydrant and attach the receiver to a helicopter nozzle by pressing the connector upward into the nozzle to secure the nozzle within the connector. Once both the receiver is attached to the nozzle and the female connector is attached to the fire hydrant, the fire hydrant can be turned on to allow water to flow through the female connector, through the tubing, through the receiver, and into the helicopter via the nozzle. Once the water filling has finished, the receiver can be removed from the nozzle by pushing the receiver and/or connector downward. Then, the female connector can be unthreaded from the fire hydrant.

Accordingly, the firefighting helicopter quick-fill system of the present invention is particularly advantageous as it provides a firefighting helicopter quick-fill system that allows a firefighting helicopter to easily receive water without requiring a large body of water or water source to fill a firefighting helicopter. Further, the device reduces the amount of travel time needed from a body of water to a wildfire by allowing a firefighting helicopter to be filled using more readily available fire hydrants. In this manner, the firefighting helicopter quick-fill system overcomes the limitations of existing methods and devices used to fill firefighting helicopters known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a firefighting helicopter quick-fill system of the present invention while attached to a male nozzle of a firefighting helicopter and a fire hydrant in accordance with the disclosed architecture;

FIG. 2 illustrates a perspective view of one potential embodiment of a firefighting helicopter quick-fill system of the present invention in accordance with the disclosed architecture; and

FIG. 3 illustrates a flowchart of one potential method of using one potential embodiment of a firefighting helicopter quick-fill system of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a system that allows a firefighting helicopter to easily receive water. There also exists a long-felt need in the art for a helicopter water-filling system that allows a firefighting helicopter to be easily filled with water to combat wildfires without requiring a large body of water or water source to fill said helicopter. In addition, there exists a long-felt need in the art for a helicopter water filling system that allows a helicopter to be easily filled with water to combat wildfires without requiring a large body of water or water source to fill said helicopter and that also reduces the amount of travel time needed from a body of water to a wildfire.

The present invention, in one exemplary embodiment, is a firefighting helicopter quick-fill system comprised of a filling device that attaches to a helicopter nozzle and a fire hydrant. The device is primarily comprised of a first end with at least one receiver and a second end comprised of at least one female connector. The first end and the second end are connected by at least one tubing. The system is also comprised of a method of using the device.

The first end of the device is comprised of at least one receiver with at least one top opening and at least one bottom opening. The top opening allows a male helicopter nozzle to connect to the device for water filling. The nozzle is received by at least one connector positioned within the receiver. The connector is preferably a plunger of any plunger type known in the art. The plunger is preferably comprised of at least one spring such that the plunger is spring-loaded. In this manner, the plunger can be pushed against the nozzle such that the plunger is secured around the nozzle.

The bottom opening of the receiver may be fixedly or removably attached to the tubing such that the receiver and tubing are in fluid communication. The tubing may be attached to the opening via at least one connecting fastener. The tubing connects to at least one female connector at the second end of the device. The tubing may fixedly connect to the connector. The tubing may also be removably connected via at least one connecting fastener. The connector preferably has at least one rear opening and at least one front opening, wherein the front opening allows a male fire hydrant connector to connect to the device for water filling. The interior wall of the connector is preferably comprised of at least one thread that is a male or female reciprocating thread which corresponds to the opposite thread found on the fire hydrant. In this manner, the connector can be threaded onto the fire hydrant using at least one handle located on the connector.

In one embodiment, the flow of water from the fire hydrant through the tubing to the nozzle can be controlled by at least one valve. In another embodiment, the device may be comprised of at least one brace, wherein a first end of the brace preferably attaches to the receiver via at least one fastener. The second end of the brace further attaches to the female connector via at least one fastener.

The system is also comprised of a method of use. First, a user can attach the female connector to a fire hydrant by turning the threads of the connector onto the hydrant and attach the receiver to a helicopter nozzle by pressing the connector upwards into the nozzle to secure the nozzle within the connector. Once both the receiver is attached to the nozzle and the female connector is attached to the fire hydrant, the fire hydrant can be turned on to allow water to flow through the female connector, through the tubing, through the receiver, and into the helicopter via the nozzle. Once the water filling has finished, the receiver can be removed from the nozzle by pushing the receiver and/or connector downward. Then, the female connector can be unthreaded from the fire hydrant.

Accordingly, the firefighting helicopter quick-fill system of the present invention is particularly advantageous as it provides a firefighting helicopter quick-fill system that allows a firefighting helicopter to easily receive water without requiring a large body of water or water source to fill a firefighting helicopter. Further, the device reduces the amount of travel time needed from a body of water to a wildfire by allowing a firefighting helicopter to be filled using more readily available fire hydrants. In this manner, the firefighting helicopter quick-fill system overcomes the limitations of existing methods and devices used to fill firefighting helicopters known in the art.

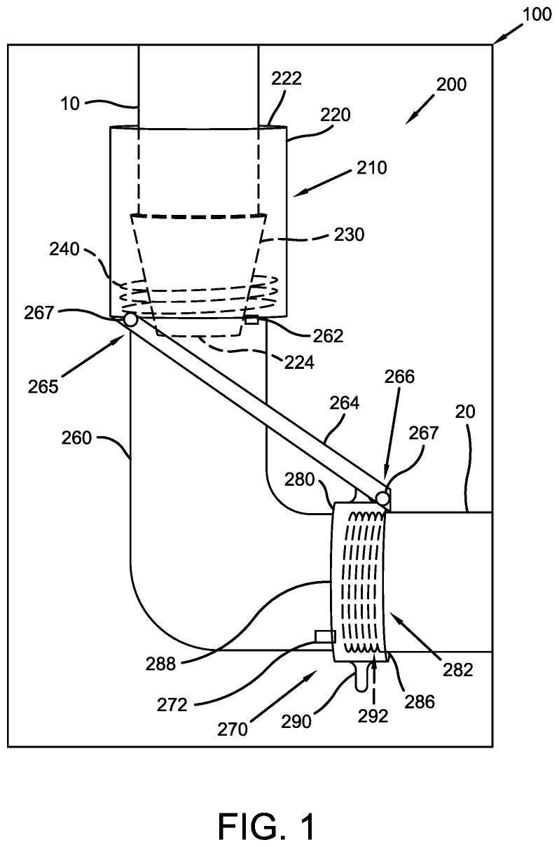

Referring initially to the drawings, FIG. 1 illustrates a perspective view of one potential embodiment of a firefighting helicopter quick-fill system 100 of the present invention while attached to a male nozzle 10 of a firefighting helicopter and a fire hydrant 20 in accordance with the disclosed architecture. The system 100 is comprised of a filling device 200 that attaches to a helicopter nozzle 10 and a fire hydrant 20. The device 200 is primarily comprised of a first end 210 with at least one receiver 200 and a second end 270 comprised of at least one female connector 280, wherein the first end 210 and the second end 270 are connected by at least one tubing 260. The system 100 is also comprised of a method of using 300 the device 200.

The first end 210 of the device 200 is comprised of at least one receiver 220. The receiver 220 may be any shape in differing embodiments but is preferably generally cylindrical and has at least one top opening 222 and at least one bottom opening 224. The receiver 220 is preferably made from a brass or other rustproof and waterproof metal or plastic material. The top opening 222 allows a male helicopter nozzle 10 to connect to the device 200 for water filling. The nozzle 10 is preferably received by at least one connector 230 positioned within the receiver 220. The connector 230 is preferably a plunger of any plunger type known in the art. The plunger 230 is preferably comprised of at least one spring 240 such that the plunger 230 is spring-loaded. In this manner, the plunger 230 can be pushed against the nozzle 10 such that the plunger 230 is secured around the nozzle. In a differing embodiment, the receiver 220 may have any other type of connector 230 style known in the art, which is preferably, but not limited to, a quick-connector type. In one embodiment, the connector 230 may be designed and adapted for use with a female helicopter nozzle.

The bottom opening 224 of the receiver 220 may be fixedly or removably attached to the tubing 260 such that the receiver 220 and tubing 260 are in fluid communication. The tubing 260 may be attached to the opening 224 via at least one connecting fastener 262 such as, but not limited to, a clamp, a clasp, a bolt, a thread, a screw, a lock, etc., or any other fastening means known in the art. The tubing 260 may be any material known in the art that can transport water without leakage. Said material includes, but is not limited to, any combination of rubber, nylon, fabric, plastic, polyester, etc.

The tubing 260 connects to at least one female connector 280 at the second end 270 of the device 200. The tubing 260 may fixedly connect to the connector 280 or may be removably connected via at least one connecting fastener 272 such as, but not limited to, a clamp, a clasp, a bolt, a thread, a screw, a lock, etc., or any other fastening means known in the art. The connector 280 may be any shape in differing embodiments but is preferably generally cylindrical and has at least one rear opening 288 and at least one front opening 286. The connector 280 is preferably made from a brass or other rustproof and waterproof metal or plastic material. The front opening 286 allows a male fire hydrant connector to connect to the device 200 for water filling. The interior 282 wall of the connector 280 is preferably comprised of at least one thread 284 which is a male or female reciprocating thread which corresponds to the opposite thread found on the fire hydrant 20. In this manner, the connector 280 can be threaded onto the fire hydrant 20 using at least one handle 290 located on the connector 280. In one embodiment, the connector 280 may be comprised of at least one fastener 292 that further secures the connector 280 to the fire hydrant 20 such as, but not limited to, a clamp, a clasp, a bolt, a thread, a screw, a lock, etc. or any other fastening means known in the art.

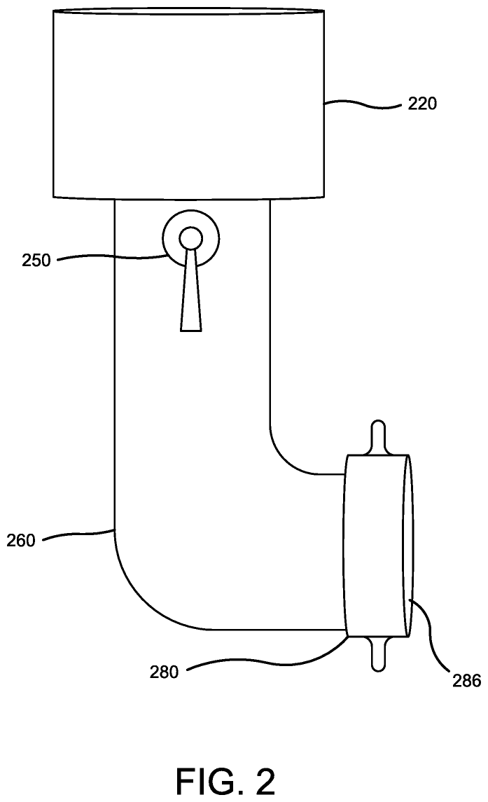

In one embodiment, the flow of water from the fire hydrant 20 through the tubing 260 to the nozzle 10 can be controlled by at least one valve 250, as seen in FIG. 2. The valve 250 may be any valve type known in the art such as, but not limited to, a ball valve, butterfly valve, check valve, gate valve, globe valve, stop valve, etc.

In one embodiment, the device 200 may be comprised of at least one brace 264. The brace 264 is preferably made from a metal or plastic material. A first end 265 of the brace 264 preferably attaches to the receiver 220 via at least one fastener 276. The second end 266 of the brace 264 further attaches to the female connector 280 via at least one fastener 276. The fastener 276 may be any fastener type known in the art such as, but not limited to, bolt, screw, hinge, clip, clasp, lock, etc.

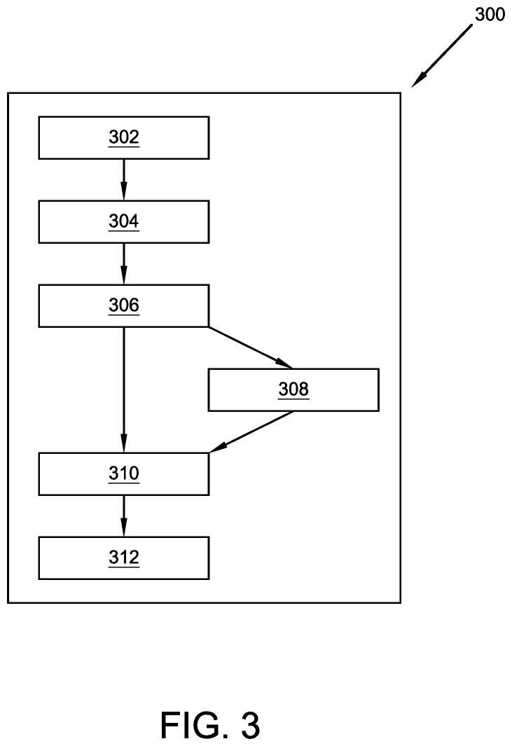

FIG. 3 illustrates a flowchart of one potential method of using one potential embodiment of a firefighting helicopter quick-fill system 100 of the present invention in accordance with the disclosed architecture. The system 100 is also comprised of a method of use 300. The first step of the method 300 is interchangeable. A user can first attach the female connector 280 to a fire hydrant 20 by turning the threads 284 of the connector onto the hydrant 20 [Step 302]. Then, a user can attach the receiver 220 to a helicopter nozzle 10 by pressing the connector 230 upward into the nozzle 10 to secure the nozzle 10 within the connector 230 [Step 304]. It is appreciated that Step 302 and Step 304 are interchangeable and can be performed in any order. Once both the receiver 220 is attached to the nozzle 10 and the female connector 280 is attached to the fire hydrant 20, the fire hydrant 20 can be turned on to allow water to flow through the female connector 280, through the tubing 260, through the receiver 200, and into the helicopter via the nozzle 10 [Step 306]. In an embodiment of the device 100 with a valve 250, the valve 250 can be opened to allow water to flow through the device 200 [Step 308]. Once the water filling has finished, the receiver 220 can be removed from the nozzle 10 by pushing the receiver 200 and/or connector 230 downward [Step 310]. Then, the female connector 280 can be unthreaded from the fire hydrant 20 [Step 312]. It is appreciated that Step 310 and Step 312 are interchangeable and can be performed in any order.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “firefighting helicopter quick-fill system” and “system” are interchangeable and refer to the firefighting helicopter quick-fill system 100 of the present invention.

Notwithstanding the foregoing, the firefighting helicopter quick-fill system 100 of the present invention and its various components can be of any suitable size and configuration as is known in the art without affecting the overall concept of the invention, provided that they accomplish the above-stated objectives. One of ordinary skill in the art will appreciate that the size, configuration and material of the firefighting helicopter quick-fill system 100 as shown in the FIGS. are for illustrative purposes only, and that many other sizes and shapes of the firefighting helicopter quick-fill system 100 are well within the scope of the present disclosure. Although the dimensions of the firefighting helicopter quick-fill system 100 are important design parameters for user convenience, the firefighting helicopter quick-fill system 100 may be of any size, shape and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A firefighting helicopter quick-fill system comprising:
a receiver having a top opening and a bottom opening;
a connector positioned within the receiver;
a female connector; and
a tubing connected to each of the bottom opening of the receiver and a rear opening of the female connector.

2. The firefighting helicopter quick-fill system of claim 1, wherein the connector is a quick-connector type fastener.

3. The firefighting helicopter quick-fill system of claim 1, wherein the receiver is in fluid communication with the female connector via the tubing.

4. A firefighting helicopter quick-fill system comprising:
a receiver having a top opening and a bottom opening;
a plunger positioned within the receiver;
a female connector comprised of an interior wall having a thread;
a tubing connected to each of the bottom opening of the receiver and to a rear opening of the female connector; and
a brace connected to each of the receiver via a first fastener and to the female connector via a second fastener.

5. The firefighting helicopter quick-fill system of claim 4, wherein the female connector is comprised of a handle.

6. The firefighting helicopter quick-fill system of claim 4, wherein the receiver is comprised of a rustproof material.

7. The firefighting helicopter quick-fill system of claim 4, wherein the female connector is comprised of a rustproof material.

8. The firefighting helicopter quick-fill system of claim 4, wherein the plunger is a spring-loaded plunger.

9. The firefighting helicopter quick-fill system of claim 4, wherein the receiver attaches to the tubing via a first connection fastener.

10. The firefighting helicopter quick-fill system of claim 9, wherein the first connection fastener is a clamp, a clasp, a bolt, a thread, a screw or a lock.

11. The firefighting helicopter quick-fill system of claim 4, wherein the female connector attaches to the tubing via a second connection fastener.

12. The firefighting helicopter quick-fill system of claim 11, wherein the second connection fastener is a clamp, a clasp, a bolt, a thread, a screw, or a lock.

13. The firefighting helicopter quick-fill system of claim 4, wherein the tubing is comprised of a rubber, a nylon, a fabric, a plastic or a polyester material.

14. The firefighting helicopter quick-fill system of claim 4, wherein the thread is female thread.

15. The firefighting helicopter quick-fill system of claim 4 further comprised of a valve.

16. The firefighting helicopter quick-fill system of claim 15, wherein the valve is a ball valve, a butterfly valve, a check valve, a gate valve, a globe valve or a stop valve.

17. The firefighting helicopter quick-fill system of claim 4, wherein the first fastener is a bolt, a screw, a hinge, a clip, a clasp or a lack.

18. The firefighting helicopter quick-fill system of claim 4, wherein the second fastener is a bolt, a screw, a hinge, a clip, a clasp or a lock.

19. A method of using a firefighting helicopter quick-fill system, the method comprising the steps of:
attaching a female connector of a filling device of the firefighting helicopter quick-fill system to a fire hydrant;
attaching a receiver of the filling device to a male nozzle of a firefighting helicopter;
turning on the fire hydrant to allow water to flow from the fire hydrant, through the tubing, through the receiver, and into the firefighting helicopter via the nozzle;
removing the receiver from the male nozzle; and
removing the female connector from the fire hydrant.

20. The method of claim 19 further comprising a step of opening a valve on the filling device such that water is permitted to flow through the filling device and into the firefighting helicopter.
